(19) United States
(12) Patent Application Publication
(10) Pub. No.: US 2002/0083612 A1
(43) Pub. Date: Jul. 4, 2002

(54) Method and apparatus for marking places for installation of fasteners

(76) Inventor: Willard I. Prather, Knoxville, IA (US)

Correspondence Address: Michael O. Sturm, HENDERSON & STURM, 206 Sixth Avenue, Suite 1213, Des Moines, IA, 50309-4076, US

(21) Appl. No.: 09/752,195

(22) Filed: Dec. 29, 2000

(51) Int. Cl. G01D 21/00

(52) U.S. Cl. 33/666; 33/613

(57) ABSTRACT

A method and apparatus for marking places for installation of fasteners. An object to be mounted on a mounting surface has a receptacle on the back thereof for receiving a fastener. This receptacle has at least a portion thereof which is generally T-shaped in cross-section. The receptacle has a first pair of walls extending from the back, this first pair of walls are spaced apart by a first distance. A second pair of walls in the receptacle are spaced farther from the back than the first pair of walls and are a second distance apart, the second distance being greater than the first distance. The marking device, which is generally T-shaped, has a stem portion disposed along a first axis. The stem portion is narrower than the first distance of the receptacle and a head portion of the marking device is sized to fit in the receptacle between the second pair of walls of the receptacle. The head portion of the marking device is narrower than the second distance along a second transverse axis to said first axis whereby the head can slide between the second pair of walls and the head portion has at least a part which is wider than the second distance along a third axis. The third axis extends through and is transverse to both the first axis and the second axis of the T-shaped marking device head whereby this head portion can be wedged against the second walls of the receptacle, thereby holding the marking device in place while the mark is made on a mounting surface. This is done with stem and of the marking device when the object is pushed against the mounting surface in the place where the object is desired to be mounted on such mounting surface.

### DESCRIPTION OF PRIOR ART

U.S. Pat. No. 5,941,046 to Prather shows a trim molding and method of installing the trim molding and uses a plurality of fasteners such as screws. These fasteners must be placed precisely at the right location in order for the trim system of the aforementioned patent to work properly. Consequently, is can be somewhat tedious to measure and mark the place for the fasteners.

Similarly, there are other instances, such as for the placement of fasteners for plaques or the like having receptacles on the rear thereof, which require measurement of the plaque and then transferring such measurement to a reference point on a wall and measuring from there to mark a place for a fastener. Consequently, there is a need for a better system for marking these places for installation of fasteners than are available in the prior art.

### BRIEF SUMMARY OF THE INVENTION

The present invention relates to a method and apparatus for marking places for installation of fasteners. An object to be mounted on a mounting surface has a receptacle on the back thereof for receiving a fastener. This receptacle has at least a portion thereof which is generally T-shaped in cross-section. The receptacle has a first pair of walls extending from the back, this first pair of walls being spaced apart by a first distance. A second pair of walls in the receptacle are spaced farther from the back than the first pair of walls and are a second distance apart, the second distance being greater than the first distance.

The marking device, which is generally T-shaped, has a stem portion disposed along a first axis. The stem portion is narrower than the first distance of the receptacle and a head portion of the marking device is sized to fit in the receptacle between the second pair of walls of the receptacle. The head portion of the marking device is narrower than the second distance along a second transverse axis to said first axis whereby the head can slide between the second pair of walls and the head portion has at least a part which is wider than the second distance along a third axis. The third axis extends through and is transverse to both the first axis and the second axis of the T-shaped marking device head, whereby this head portion can be wedged against the second walls of the receptacle, thereby holding the marking device in place while the mark is made on a mounting surface. This is done with the stem and of the marking device when the object is pushed against the mounting surface in the place where the object is desired to be mounted on such mounting surface.

It is an object of the present invention to provide an improved method and apparatus for marking places for installation of fasteners.

Another object of the present invention is to provide such an apparatus and method for an object having a receptacle in the back thereof with a T-shaped cross-section.

A further object of the present invention is to provide a method and apparatus for marking a place for a fastener to be attached which allows the user to merely push the object to be fastened to the supporting surface against the supporting surface such that the marking device will make a mark at the place where a fastener should be installed.

Other objects, advantages, and novel features of the present invention will become apparent from the following detailed description of the invention when considered in conjunction with the accompanying drawings.

### BRIEF DESCRIPTION OF THE SEVERAL VIEWS OF THE DRAWINGS

FIG. 1 shows a trim molding partially installed around a door opening, a window opening and around the base of a wall;

FIG. 2 is a cross-sectional view of the door or window opening and the trim molding of the present invention taken along line 2-2 of FIG. 1 and showing how the present invention is used to mark a place for installation of a fastener;

FIG. 3 is a rear view of a door or window trim molding using the present invention as viewed along lines 3-3 of FIG. 2;

FIG. 4 is a bottom view of the base molding of the present invention as viewed along lines 4-4 of FIG. 3 and also shows a marking device of the present invention disposed in the receptacle thereof;

FIG. 5 is a perspective view of a receptacle in an object to be mounted to a supporting surface and showing the marking device of the present invention disposed therein, showing first in dashed lines how it is inserted and then in solid lines above it where it has been rotated about a first axis to a position where it is held securely in place for marking a spot on a supporting surface;

FIG. 6 is a rear perspective view of the present invention shown on the back of a wooden plaque having a receptacle disposed therein for receiving a wall mounted fastener;

FIG. 7 is a front perspective view of the plaque shown in FIG. 6 and showing the fastener in a wall and the receptacle in dashed lines;

FIG. 8 is a perspective, enlarged view of the marking device of the present invention;

FIG. 9 is a cross-sectional view taken along line 4-4 of FIG. 3 and showing x and y dimensions thereon; and

FIG. 10 is a top view of the marking device of the present invention viewing it from the pointed end extending up, and relationships among dimensions of FIGS. 9 and 10.

### DETAILED DESCRIPTION OF THE INVENTION

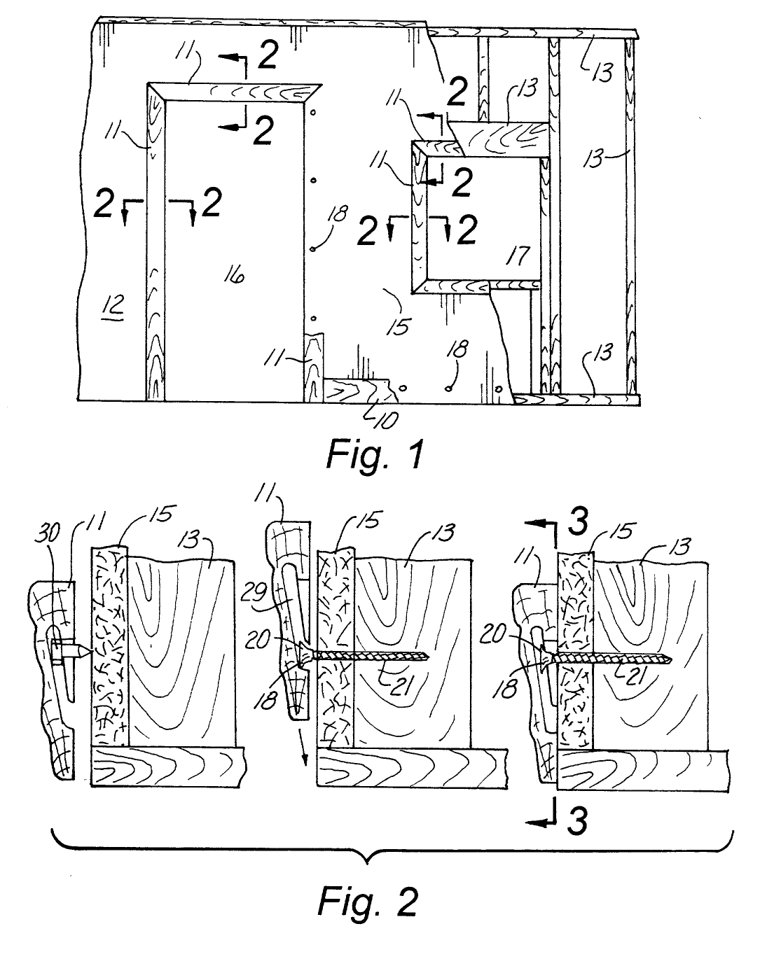

Referring now to the drawings wherein like reference numerals designate identical or corresponding parts throughout the several views, FIG. 1 shows a typical mounting surface (12) for trim molding (10 and 11). In most new and existing homes the mounting surface (12) for the trim molding (10 and 11) will be constructed of wood or timber framing (13) to which drywall panels are attached. FIG. 1 shows the base trim molding (10) partially installed at the base of the wall (15) and door and window trim molding (11) partially installed around a door opening (16), and around a window opening (17). Connectors (18), having an enlarged head portion (20) and a narrower neck portion (21), are shown installed at predetermined locations around the perimeter of the door opening (16) and base of the wall (15) where the trim (10 and 11) has not yet been installed.

In the preferred embodiment, the connectors (18) are drywall screws. This is substantially the same as shown in U.S. Pat. No. 5,941,046 to Prather, which is incorporated herein by reference. The marking device (30) shown in FIGS. 2-4, 5, 6, 8 and 10 in a preferred embodiment is made of nylon, but could be made of many other plastic materials or of metal of almost any type. The marking device (30) has a stem (31) and a head (32).

As shown in FIG. 8, the marking device (30) is rotatable about an axis (1) which is preferably centrally located through stem portion (31). The head (32), as most clearly shown in FIG. 10, has a width a in one direction and a width b in another direction. Similarly, the stem has a narrow width c and a wider width d. An axis (3) extends lengthwise through the head (31) and the axis (2) is perpendicular to both axis (1) and axis (3) as can be seen in FIG. 8.

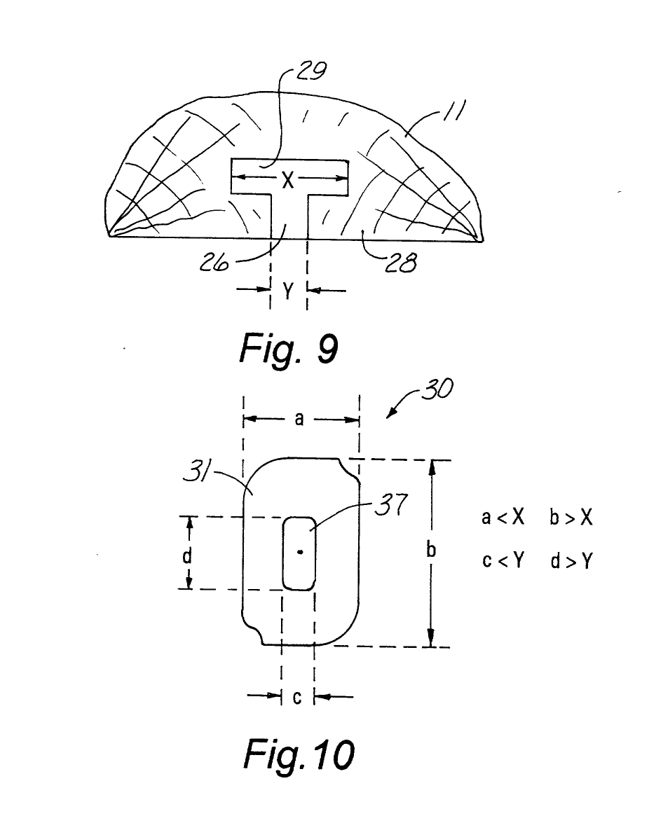

Referring to FIGS. 9 and 10, it is noted that the width a of the head (31) is less than x, the length of slot portion (29) in the object (11) to be mounted on a mounting surface. The distance b of the head (31) is greater than the distance x for reasons which will be explained below. Similarly, the distance c of the stem (31) is preferably less than the distance y of T-shaped slot portion (26) in the object (11) to be mounted and distance D of the stem (31) is preferably greater than the distance y.

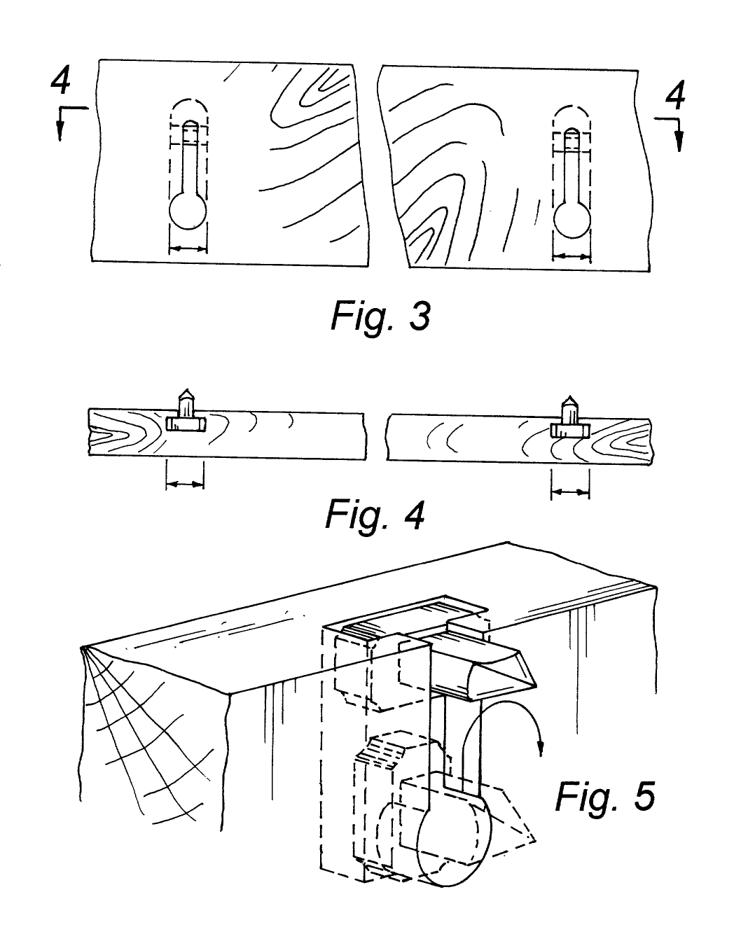

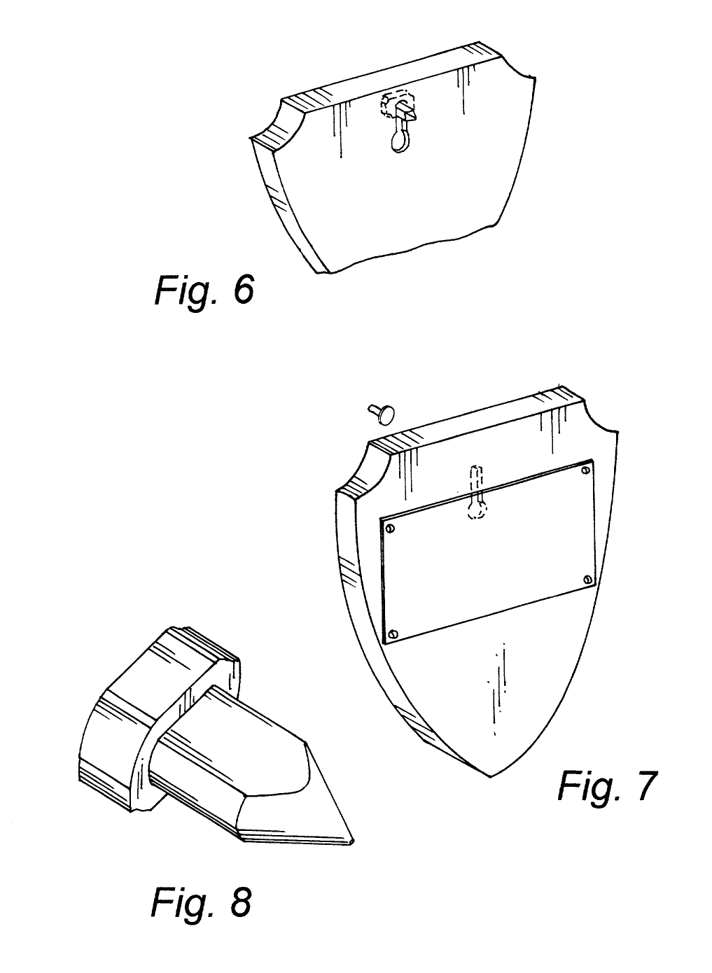

In operation, the marking devices (30) would be placed in a receptacle, for example as shown in FIG. 5, wherein the rounded portion (25) of the receptacle is large enough to receive the head (31) of the marking device (30). In other words, the diameter of opening (25) is slightly greater than the distance b shown in FIG. 10. The slot shown in FIG. 5 is such that the marking device (30) can enter on one end of the receptacle, such as in the baseboard embodiment shown in FIG. 2 of U.S. Pat. No. 5,941,046 or it can enter through the opening (25) as shown in FIG. 3 of a portion which goes around a window or the like in FIG. 1. Similarly, it can be like the plaque (40) shown in FIGS. 6 and 7.

Once the marking device (30) enters the receptacle either through the round opening (25) or the top thereof, it can then be easily slid along the receptacle in the dashed line position shown in FIG. 5 because of the relationships between the dimensions shown in FIG. 10. Once it is shown in the position desired for a fastener to be received in the receptacle, it is rotated about axis (1) to the position shown in solid lines in FIG. 5 whereupon it will be wedged against the walls of portion (29) of the receptacle. This also causes the walls of stem (31) to be tight against the walls (26) of the receptacle. It is to be understood that it is not necessary for both the head (31) distance b to be larger than distance x and that the distance d be larger than the distance y, but only that one of these relationships exist. It is quite adequate for the marking device (30) to be held at either of these places or at both places if desired.

Once the marking device (30) is wedged into place, for example as shown on the left side of FIG. 2, then the object (11) can be held in the place to which it is to be installed and pushed against the supporting surface (15) in FIG. 2, thereby indenting the surface of supporting surface (15). This would be done in the case of a baseboard or window trim or door trim by having one of the marking devices (30) in each of the receptacles of such trim piece. Therefore, when the trim piece is pushed against the supporting surface (15), each place where there is a receptacle, a marking device would mark the supporting surface (15).

After this process, then fasteners such as screws (18) would be inserted into the supporting surface (15), and possibly into studs (13) in many instances, so that once the screws or other fasteners (18) are so attached, the trim members (11) can be easily slipped on and off of the walls as desired. Similarly, this concept can be used for the back of a plaque (40), for example as shown in FIGS. 6 and 7 wherein the marking device (30) is received first through the opening (25) and then is slid up and rotated to the position shown in FIG. 6 in dashed lines. The plaque (40) is then pushed against a wall to make a mark. Then a nail (38) or other fastener is placed into the wall, the marking device (30) is removed and then the nail (38) is received through the opening (25) and the plaque is pulled downwardly, such that the head of the nail (38) is securely in the receptacle (26) and (29).

Consequently, it will be appreciated that the preferred embodiment disclosed herein does indeed accomplish the aforementioned objects. Obviously many modifications and variations of the present invention are possible in light of the above teachings. It is therefore to be understood that, within the scope of the appended claims, the invention may be practiced otherwise than as specifically described.

1. Apparatus for marking places for installation of fasteners comprising:
an object having a receptacle on the back thereof, at least a portion of said receptacle being generally T-shaped in cross section, said receptacle having a first pair of walls extending from said back, said first pair of walls being a first distance apart and a second pair of walls spaced farther from said back than said first pair of walls, said second pair of walls being a second distance apart, said second distance being greater than said first distance; and
a marking device which is generally T-shaped, said marking device having a stem portion disposed along a first axis, said stem portion having at least a part which is narrower than said first distance and a head portion sized to fit in said receptacle between said second pair of walls, said head portion being narrower than said second distance along a second axis transverse to said first axis whereby said head can slide between said second pair of walls and said head portion having at least a part thereof which is wider than said second distance along a third axis extending through and being transverse to both said first axis and said second axis whereby said head portion can be wedged against the second walls, thereby holding said marking device in place while a mark is made on a mounting surface with the stem end of said marking device when said object is pushed against the mounting surface in the place where the object is desired to be mounted on said mounting surface.

2. The apparatus of claim 1 including a pointed end on said stem portion of said marking device for facilitating said mark being easily made in said surface.

3. A method of marking places for installation of fasteners using an object having a receptacle on the back thereof, at least a portion of said receptacle being generally T-shaped in cross section, said receptacle having a first pair of walls extending from said back, said first pair of walls being a first distance apart and a second pair of walls spaced farther from said back than said first pair of walls, said second pair of walls being a second distance apart, said second distance being greater than said first distance; and a marking device which is generally T-shaped, said marking device having a stem portion disposed along a first axis, said stem portion being narrower than said first distance and a head portion sized to fit in said receptacle between said second pair of walls, said head portion being narrower than said second distance along a second axis transverse to said first axis whereby said head can slide between said second pair of walls and said head portion having at least a part thereof which is wider than said second distance along a third axis extending through and being transverse to both said first axis and said second axis whereby said head portion can be wedged against the second walls, thereby holding said marking device in place while a mark is made on a mounting surface with the stem end of said marking device when said object is pushed against the mounting surface in the place where the object is desired to be mounted on said mounting surface; said method comprising:
placing said marking device into said receptacle so that said head portion will slide between said second pair of walls to the place where a fastener will ultimately be positioned;
pivoting said marking device about said first axis until said head portion is wedged against said second pair of walls;
placing said object on said mounting surface in a place where it is desired to mount said object;
pushing said object so that the stem portion of said marking device makes a mark on said mounting surface;
placing a fastener in said mounting surface where said mark was made on the mounting surface, said fastener having a stem and an enlarged head sized to fit in said receptacle;
removing said marking device from said receptacle; and
placing said object on said mounting surface so that said enlarged head of said fastener is received in said receptacle and said object is thereby held in place on said mounting surface.

4. Apparatus for marking places for installation of fasteners comprising:
an object having a receptacle on the back thereof, at least a portion of said receptacle being generally T-shaped in cross section, said receptacle having a first pair of walls extending from said back, said first pair of walls being a first distance apart and a second pair of walls spaced farther from said back than said first pair of walls, said second pair of walls being a second distance apart, said second distance being greater than said first distance; and
a marking device which is generally T-shaped, said marking device having a stem portion disposed along a first axis, said stem portion having at least a part which is narrower than said first distance and a second part which is wider than said first distance, and a head portion sized to fit in said receptacle between said second pair of walls, said head portion being narrower than said second distance along a second axis transverse to said first axis whereby said head can slide between said second pair of walls whereby by pivoting said marking device about said first axis said stem portion can be wedged against the first walls, thereby holding said marking device in place while a mark is made on a mounting surface with the stem end of said marking device when said object is pushed against the mounting surface in the place where the object is desired to be mounted on said mounting surface.

5. The apparatus of claim 4 wherein said head portion has at least a part thereof which is wider than said second distance along a third axis extending through and being transverse to both said first axis and said second axis whereby said head portion will be wedged against the second walls when the stem portion is wedged against the first walls.

6. A method of marking places for installation of fasteners using an object having a receptacle on the back thereof, at least a portion of said receptacle being generally T-shaped in cross section, said receptacle having a first pair of walls extending from said back, said first pair of walls being a first distance apart and a second pair of walls spaced farther from said back than said first pair of walls, said second pair of walls being a second distance apart, said second distance being greater than said first distance; and a marking device which is generally T-shaped, said marking device having a stem portion disposed along a first axis, said stem portion having at least a part which is narrower than said first distance and a second part which is wider than said first distance, and a head portion sized to fit in said receptacle between said second pair of walls, said head portion being narrower than said second distance along a second axis transverse to said first axis whereby said head can slide between said second pair of walls whereby by pivoting said marking device about said first axis said stem portion can be wedged against the first walls, thereby holding said marking device in place while a mark is made on a mounting surface with the stem end of said marking device when said object is pushed against the mounting surface in the place where the object is desired to be mounted on said mounting surface, said method comprising:
placing said marking device into said receptacle so that said head portion will slide between said second pair of walls and said stem will slide between said first pair of walls to the place where a fastener will ultimately be positioned;
pivoting said marking device about said first axis until said stem portion is wedged against said first pair of walls;
placing said object on said mounting surface in a place where it is desired to mount said object;
pushing said object so that the stem portion of said marking device makes a mark on said mounting surface;
placing a fastener in said mounting surface where said mark was made on the mounting surface, said fastener having a stem and an enlarged head sized to fit in said receptacle;
removing said marking device from said receptacle; and
placing said object on said mounting surface so that said enlarged head of said fastener is received in said receptacle and said object is thereby held in place on said mounting surface.
